(19) United States
(12) Patent Application Publication
(10) Pub. No.: US 2017/0286862 A1
(43) Pub. Date: Oct. 5, 2017

(54) SYSTEM FOR MIRRORING HUMAN MEMORY AND GENERATING A THREE-DIMENSIONAL CLONE OF PERSONALITY

(71) Applicant: Mokhtar Mourabit, New York, NY (US)

(72) Inventor: Mokhtar Mourabit, New York, NY (US)

(21) Appl. No.: 15/089,859

(22) Filed: Apr. 4, 2016

(51) Int. Cl. G06N 99/00; G06N 3/10

(52) U.S. Cl. CPC G06N 99/005; G06N 3/10

(57) ABSTRACT

A computing and logic system for mirroring human memory involved in everyday role play, and printing a 3D clone of personality as an algorithm of prediction for feelings, thought patterns and behaviors in different situations of life. A user's computing device and mobile application installed on the user's device provide interaction between the user's device and a remote server running a server application, and a database, and aims to to help the user know themselves better through everyday situations. The server application is operatively coupled to the mobile application, which is adapted and configured to relay tailor-fitted text, audio and video content between the user and the server application via a web browser or the user's device. The server application and mobile application are adapted and configured to permit the user to interact anonymously with the server via a web site or the mobile application.

### FIELD

The invention relates generally to systems for conducting decision processes as well as personal, professional and social development (self-assessment and self-learning) via an automated and intelligent system.

### BACKGROUND

Everything proceeding from the brain's activity is a fact of memory. Learning, talking, judging, comparing, estimating, feeling, inventing, reacting, and many others are all examples of this principle. It means every thought is a simultaneous objective and subjective point of view of the reality.

For example, looking at the sky generates objective inputs coming from outside the brain, such as light, radiation, clouds, motion, and also various subjective inputs coming from inside the brain, including beauty, sadness, joy, color, and temperature. As all inputs involved in the brain activity proceed from human memory—including sensory, working and long-term memories—the interpretation of the sky in this example depends on the way these inputs are finally combined and emotionally encrypted in the limbic system. Processing these inputs involves the explicit (conscious), the implicit (unconscious), the procedural (skills), the declarative (events), the semantic (words) and the episodic (experience) memories, all at once.

Every second, a new combination is created, billions of which are encrypted in the temporal lobes, but only a part of them are then filtered by the limbic system to access the conscious mind. Thus the human memory can be considered as a “black box” containing billions of combinations of memories influencing people's everyday life, blindly.

Traditional psychological help, where an individual meets face-to-face with a professional, introduces a number of interfering variables and distractions, resulting from the presence of the professional. The professional may act as a source of interference or contamination in the process, the individual may be reticent and dishonest, or the individual may reject the professional's instructions.

An individual's feelings, thought patterns, and behaviors define the three dimensions of personality. Personality can now be defined as the three-dimensional way individuals choose a tradeoff between fear of suffering and hope to become the highest form of themselves. These fears and hopes are unique and particular, and people are the only ones to actually know the intimate truth about it.

Many people do not act according to their intimate truth about fear and hope because they don't even know, they don't want to know, or they don't want to let anyone else know about it. Many have simply locked it into the “black box” of the temporal lobes, and the related combinations of inputs are remained beyond the limbic system. The reasons for this are: (1) the process is totally unconscious and (2) there is a vital necessity to prevent the neuronal connections from activating the deepest fear (suffering combinations of inputs).

Because of this “black box” in the brain, people cannot interact directly (freely) to the real world, because too much information is blindly filtered by the limbic system. In order to live their lives despite it, they naturally try to overtake this inconvenient truth about themselves by attempting to get the control on each and every aspect of their individual reality, or the convenient interpretation of the real world. People seek control by striving to be attractive, keeping the best standard of health, appearing as smart as possible, targeting perfection, succeeding at every challenge, and so on. When they fail, they inevitably feel broken, experiencing illness, breakdown, burnout, addictions, alcoholism, suicidal tendencies, violence, and so on.

All disciplines of the mind in the pursuit of learning, studying and evolving could be considered as attempts to bridge the gap between the reality and the real world, and re-conquer their original freedom, if possible, before dying. For this meaningful reason, people follow social principles, go to school, respect morality, learn science, mathematics, physics, medicine, practice sports, arts, communication, and enter into relationships.

According to this logical thought pattern, the more people try to bridge the gap to their freedom by communicating (learning and doing efforts) to other people, the more they reinforce the belief that one day they will succeed thanks to a sufficient level of control. This belief is good at the social level in order to live together, but is dramatically wrong at the individual scale because it cannot help actualize the self.

As people hate to fail, they also hate to recognize they might be following the wrong path in their logical and legitimate pursuit of freedom and happiness. Then, most of them will keep pushing the way they know best, trying to finally succeed by doing more, better, faster, and so on. At the end of the road, most of them will be rewarded by a deep fatigue, and will visit professionals to get some help. Unfortunately, this solution includes the risk to try another “same” attempt to get control, this time in the worst state of mind for such a huge amount of efforts.

Generally, according to recent knowledge about human memory and facts of memory, classical psychological help has to overtake three main issues:

First, there is a presupposition that the professional observing, assessing and treating the individual is not a source of interference or contamination himself, due to his own interpretation of reality about the individual (cf. the “sky”). In fact, the Heisenberg's principle of uncertainty says it's not possible for an observer to stay out of the experience. Thus, the simple fact that a professional is searching for a diagnosis, he interferes with his individual and sometimes can even encourage new symptoms, as revealed in hysteric disorders.

Second, there is a presupposition that the individual is talking freely and sincerely about his problems, and that he can do so because he is able to explain it. Practitioners know individuals are not willing to do that. If they were, they simply wouldn't be visiting a professional. Thus there's a great uncertainty about the truthfulness in the talking cure. In fact, as said previously, the probability that the individual is lying (hiding truth) to himself is very important: the limbic system is more disturbed than ever.

Third, there is a presupposition that the solution coming from the practitioner will be naturally accepted by the individual in the name of science. This presupposition also considers that the individual and the intervener actually have the same goal through the sessions. The individual will resist because they don't want to change, they don't want to modify the balance they've found in their personality as a trade-off between fear and hope. They visit the intervener with the intimate intent to get back the control on their life, not changing anything if not needed. The intervener has his own goals too: working for a living, demonstrating skills, honoring the therapy school he's from, being useful to others, keeping control on his own life.

Accordingly, what is needed is a system in which psychological help and related services may be delivered in an environment in which the three foregoing issues are mitigated.

What is further needed is a system in which and psychological help and related services may be delivered in which a three-dimensional model of an individual's personality may be developed, structured, and stored, and utilized in performing self improvement.

What is further needed is a system and method for mirroring human memory in everyday role play, and printing a three-dimensional clone of personality to enable prediction of feelings, thought patterns and behaviors in different situations of life.

### BRIEF DESCRIPTION OF THE DRAWINGS

FIG. 1 is a flowchart describing the logic behind the system of the present invention.

FIG. 2 is a functional block diagram showing components of an embodiment fo the present invention.

FIG. 3 is a flowchart describing an exemplary use of the system of the present invention.

FIG. 4 is a simple sequential diagram illustrating principles of the present invention.

FIG. 5 is a functional block diagram of an exemplary logical circuit for use with the present invention in which three sequential systems are described.

FIG. 6 is a chronogram describing the logic of embodiments of the present invention.

FIG. 7 is a block diagram describing an exemplary application using a system inherent to digicodes and elevators.

FIG. 8 is a functional block diagram illustrating components of an embodiment of the present invention.

FIG. 9 is a functional block diagram illustrating components of an embodiment of the present invention.

FIG. 10 is a graphic describing logic sequences utilized in embodiments of the present invention.

FIG. 11 is a depiction of various states of the system of the present invention.

FIG. 12 depicts an example of an elevator shown with the interlocutor as the person answering the questions.

FIG. 13 shows a logical circuit in which a state graph is designed from the initial state chosen.

FIG. 14 is a state diagram illustrating another state of the system of the present invention.

FIG. 15 is a state diagram illustrating another state of the system of the present invention.

FIG. 16 is a state diagram illustrating another state of the system of the present invention.

FIG. 17 is a Grafcet diagram describing elements of the system of the present invention.

FIG. 18 is an illustration demonstrating the evolution of the Grafcet.

FIG. 19 illustrates the package of steps and transitions for a single command within the application of the present invention.

FIG. 20 shows a state diagram related to the illustration of FIG. 19.

FIG. 21 is a flowchart describing logic elements utilized in the present invention.

FIG. 22 is a Karnaugh map describing logical circuits utilized with the present invention.

FIG. 23 is a Karnaugh map describing logical circuits utilized with the present invention.

FIG. 24 is a logic diagram illustrating elements of the present invention.

### DETAILED DESCRIPTION

A system and method is described for mirroring human memory in everyday role play, and printing a three-dimensional clone of personality to enable prediction of feelings, thought patterns and behaviors in different situations of life.

In embodiments, the invention is a special-purpose machine with which people can interact, based on an algorithm able to decrypt the facts of memory people experience everyday into meaningful knowledge about their real intents hidden behind the limbic system and building their relationships.

For example, smoking cigarettes is a behavior people can hardly explain. They justify and legitimate it easily but the real intent is never clear. This situation is most likely due to a suffering combination of inputs locked in the temporal lobes and associated to information that have nothing to do with the fact of smoking, at least not directly. Why do they smoke, then? They smoke because a suffering combination of inputs (due to different causes) is continuously trying to get a painful connection to the conscious. In order to prevent the intolerable pain, the limbic system will filter the inputs and redirect them toward another more convenient outcome: a painful uncontrollable feeling is turned into a controllable behavior that presents sufficient similitude to lure the mind, not enough similitude to let the person be aware of the painful feeling itself (amazing natural unconscious trade-off).

In the example above, a person who has previously generated his three-dimensional clone of personality decides to inquire the machine about his smoking habit he wants to quit. The system screens the three-dimensional clone of personality (analysis of all facts of memory involved in the behavior) and calculates the probabilities for each and every possible memory causing the habit in his particular case, and organizes them in a hierarchical order.

Assume for example that the machine analysis has identified “a deep fear of being rejected by the beloved ones” as the most likely cause of smoking behavior in an attempt to get the control back on events that the person can't control. According to the three-dimensional clone of personality, the machine has then identified the fear of rejection as the main fact of memory building the personality, and all experiences flowing from it. The generated experiences of rejection will then reinforce the belief that the person is cursed and will always be rejected, despite the sum of efforts to “change” it. In this context, the simple behavior of smoking appears to be an island of peace and control in a deep ocean of fear to be rejected. The original combination of inputs trying to make its way through conscious could probably be expressed as: “you are not welcome in this world and you are then not free to exist.”

Once the system has organized the probabilities of memory causing the painful input, once it has estimated the emotional, cognitive and behavioral available resources (three-dimensional clone), the algorithm will virtually generate new customized situations for the person, with the purpose to help him: (1) complete his profile, (2) redefine his reality, (3) discover general aspects of his personality he has been ignoring so far, and (4) adjust behavioral patterns (reinforcing resources) in every new situation, just like in a role play. The machine never sends any response neither directly, nor indirectly. The machine is processing like a “mirror” the person can consult anytime.

In front of each situation in everyday life, people need to call different abilities in order to take the best of the experience. When they don't have the required abilities, they try to adjust with the abilities they know already (coping strategy). But sometimes, even coping strategies fail and then people may feel totally overtaken. If the situation repeats or last too long, they simply enter into distress. Again, in our example, let's assume the algorithm has identified the smoking behavior pattern as an unconscious attempt to escape from the painful feeling of being someone of a very poor interest. In different virtual situations where the person his highly expected to activate the painful feeling (and then activate a very huge desire to smoke a cigarette), the machine will present the person's available resources (attitude) as well as other resources that other people activate to handle the same situation. For each attitude (including feelings, thought patterns and behavior), the system calculates the probabilities of final outcome with impact on every aspect of personality (emotion, beliefs, behaviors).

The invention's purpose is in part about choosing an attitude fitting one's personality, in a situation. The user is never exposed to a presumed “good response” he is supposed to do, he is invited to consider a selected range of attitudes leading to statistical outcomes, he has to enter the situation and find out by himself what he wants to choose, according to his personal timing and real intent.

A user of the system may be more free and open with information and feelings in a seemingly anonymous setting where the user is not concerned with the system's thoughts or opinions of what the user is sharing. Interference by the intervener is obviated where the only interaction is with the system of the present invention. The system of the present invention offers substantially more than a simple question-and-answer method for choosing an outcome and instead offers an enhanced system tied to a particular implementation. The physical implementation of the present system is integral to the invention. Without that implementation, the system is no better than traditional methods and their concomitant limitations.

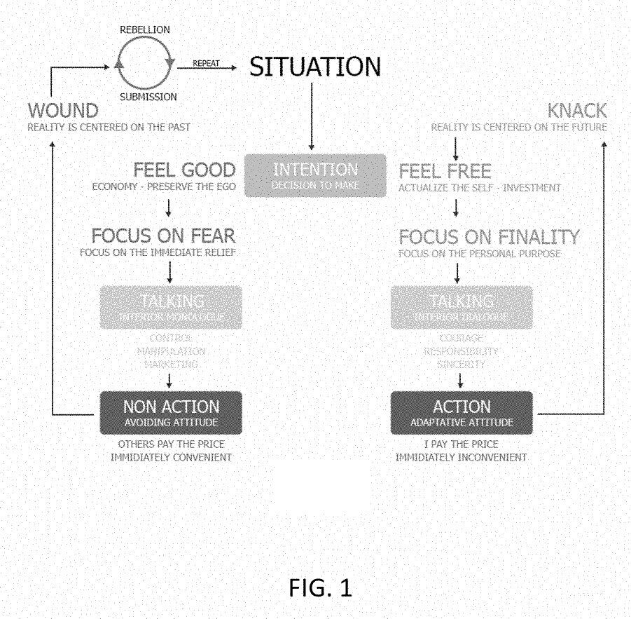

Referring now to FIG. 1, a flowchart describing the logic behind the system of the present invention. In everyday life, people may face situations and challenges (110), and according to personality, some situations may even generate distress. At the moment of the situation or challenge, a decision has to be made (120) relative to the situation or challenge, and most of the time, this decision is even not conscious. A choice has to be made between “what makes people feel good” (130) and “what makes people feel free” (140), and the decision between the two may reveal the general intention about one's life.

If a person chooses to feel good (130), they may be seeking an immediate and economic outcome, i.e., preserving the image of oneself (ego) as a still representation of personality that should never be too much modified. Focusing on immediate relief (130) in case of distress places the fear right at the center of one's reality (150), as the most influential part of all experiences: everything in brain activity is about avoiding the fear. The way people are talking to themselves (160) is based on getting control, using manipulation and marketing. This interior monologue is violent because one part of the personality is dominating the other and is forcing to do as said: this monologue is the rehearsal of a dominator/dominated relationship that leads to an avoidance, sabotage or rebellion. This passive attitude makes people believe they are either the executioner, or the savior or the victim.

FIG. 1 represents how the individual reacts according to a situation (or several situations), according to the intention the individual will imprint to one's reaction (the intention represents the whole memory enclosed in the limbic system). This reaction leads to either an action or an inhibition generating a vicious circle the person cannot leave, apparently. The 3D-clone will push the person into action by stimulating his whole memory according to his intention, and by stimulating his knack(s) so that he can change the way he's making his decisions in the future. Reactions to the new situations are more and more appropriate, various, original and specific. The 3D-clone then reveals the coping abilities of the individual.

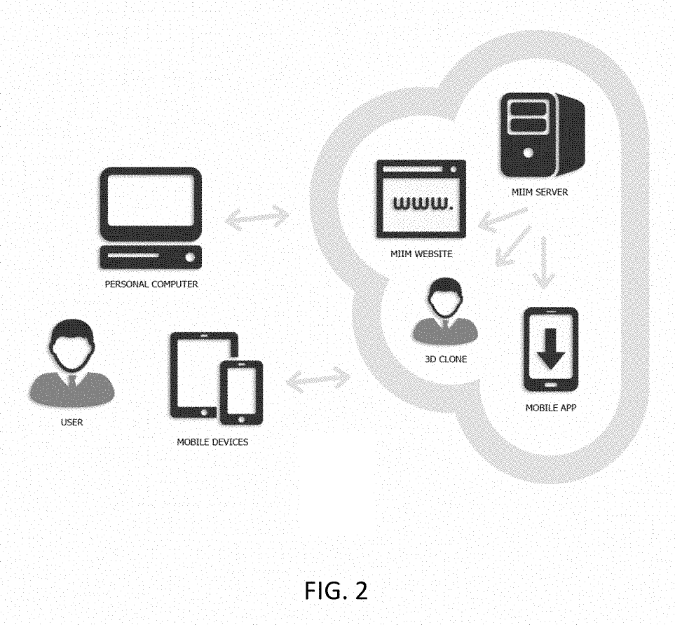

Referring to FIG. 2, a functional overview of the system of the present invention is shown. In an exemplary system a computing device 210 may be provided in the form of a personal computer, such as a desktop computer or laptop computer. In embodiments, the computing device may be a mobile computing device such as a tablet computer or smartphone.

Application software 220 may be installed on computing device 210 for coordinating communication between computing device 210 and a remote system. Application software 220 may be downloaded from a remote server or provided to the user directly on computer-readable media. In embodiments, application software 220 may be installed on a remote server and accessed via a network connection. In such a cloud computing configuration, application software 120 may be omitted.

In embodiments, application software may be installed on computing device 210 to coordinate interaction between the computing device and other components in the system. As will be discussed in greater detail below, application software 220 may be the primary access point to the system for a user, providing output to the user in the form of answers, and receiving input from the user in the form of questions. The logical process targeting a more and more accurate profile (3D clone) is dynamic and sequential: each and every new question asked from the system to the user is answered by the user. Each and every new answer from the user to the system is then a new input for the system. The more it goes, the more precise becomes the profile.

In embodiments, a server 230 may be provided and operatively coupled to the Internet or a network Internet.

In embodiments, a server application may be resident on the server to provide functionality to users of the system via a network connection. The server application may provide functionality akin to a web site and deliver content accessible by a web browser on the user's device. Alternatively, server application may communicate with application software installed on the user's device.

Application software may be adapted and configured to relay tailor-fitted text, audio and video content between the user and the server application. The server application and the mobile application are adapted and configured to permit the user to interact anonymously with the server via the web site or application software.

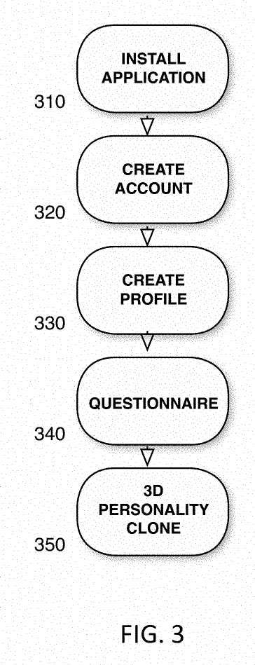

Referring to FIG. 3, a flowchart showing an exemplary use of the system is provided. A user first may download and install (step 310) application software to to local computing device. In embodiments, versions of application software are available for different types of computing devices including personal computers and mobile computing devices.

Following download and installation, a user may create (step 320) a secure personal account with login credentials. A user profile may then be generated (step 330), using information from the user such age, gender, and preferences.

A detailed questionnaire may then be presented (340) to the user. In embodiments, virtual situations are presented to the user in order to stimulate specific facts of memory. For each item the system may save emotional, cognitive and behavioral facts of memory the user does select.

A three-dimensional clone of personality may then be generated (step 350). In embodiments, three-dimensional personality clone is a data structure formulated to capture facts of memory coming through three distinct modalities: (1) feelings (body, needs, instincts, impulses); (2) thought patterns (logic, coherence, beliefs, values, principles, abstraction, creativity); and (3) behaviors (actions, reactions, non-action).

It has been found that in embodiments of the invention, the interaction between the system and the user may achieve results that could not be achieved with traditional human-to-human interaction.

According to embodiments of the invention, preliminary three-dimensional personality clone may be generated based upon on all the facts of memory the user mentioned in the questionnaire. As interaction between the user and the system progresses, the three-dimensional personality clone may be supplemented and expanded as layers of the personality clone are completed. In an exemplary embodiment, 13 layers are contemplated including, security, coherence, meaning, survival, limit, support, recognition, belonging, attachment, control, respect, justice and legitimacy. These layers of the personality reflect the multiple layers of the user's personality.

In embodiments, software running on the server may calculate the probabilities for the user to activate one or more of the layers in his everyday life. In embodiments, layers include: relationship, work, conflicts, authority, couple, self-confidence, distress or disorder. The system may also calculate the consequences of using a different layer of personality in every situation, so that the user is able to adjust his behaviors. After each and every new experience, the user discovers a new angle leading to a new definition of himself. The more the user is consulting the system, the more he investigates all layers of his personality, a process that may release the memory as well as new potentialities.

In embodiments, 3D personality clone may be stored as data in a database or other data structure such as a graph, tree, or any combination thereof.

Specific details of the implementation of the above concepts will now be described.

The concept being described, the realization of the application starts from several aspects and logical functions sustaining the technical development explained later.

The Nash Equilibrium and Pareto-Domination:

We can define a simple strategic categorization, namely, two speakers (our clones) each disposing of binary options. Four categories may occur: (1) Options having two Nash Equilibriums. (2) Options having one and only one inefficient Nash Equilibrium (Pareto-dominated). The so-called “prisoner's dilemma” is an example of this scenario. (3) Options having one and only one inefficient Nash Equilibrium (non-Pareto-dominated). The “battle of the sexes” is an example. (4) Options with no apparent Nash Equilibrium. The game of “matching pennies” is one such example.

Profligacy or absence of equilibriums as well as the inefficiency of the unique equilibrium may be the source of issues seeking for other logical functions to be integrated in the software here identified.

The presentation of the options in a sequential process is responding to and fixing these issues by waiving the hypothesis of simultaneity, which may help the option be solved by turning the clock back, a very important concept within our sequential pattern.

Options are presented by a graph oriented from left (starting point) to right (final exits) in which every bifurcation matches with the option taken by one clone or the other, results being represented by a couple of numbers. An analysis is then made of the choice made by the second speaker facing the action made by the first speaker he already knows (since the choice is sequential). In that form (provided that results are different) the solution is always unique, and we avoid the second-worst if the credible commitment doesn't match the ex-post and does engage in a brinkmanship strategy, i.e., a choice made on the blink of the precipice.

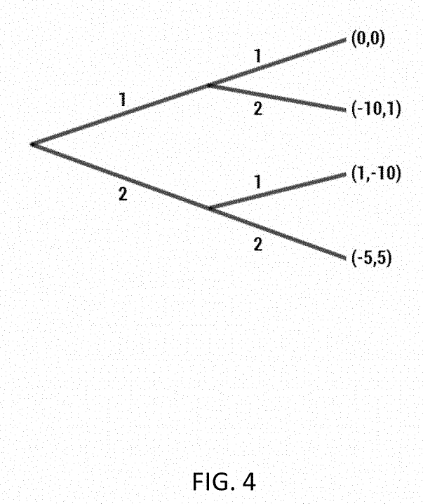

FIG. 4 contains a simple sequential diagram illustrating this principle. Referring to FIG. 4, if the player A plays 1, then the player 2 will surely play 2, aiming to win 1. The loss for player A would then be maximal, −10. Therefore, the player A will play 2, and as a result of, the player B will play 2 as well.

At this stage the informative context is not explicitly modeled and an ambivalence exists in information exchange between the user and his clone. This can be fixed by the inclusion of a sequential model of cooperation waiving the prisoner's dilemma.

The first context is the supposition that every choice is conditioned by the knowledge of the ending for one's own results as well as those for one's own alter ego, or clone, in the context of the present invention.

In embodiments, the present invention raises this hypothesis by accepting the Bayesian paradigm, i.e., that the existence of a priori subjective probabilities adjustable according to the facts on the ground. In the Bayesian approach peaking with the perfect Bayesian equilibrium, the principle of uncertainty on results is formalized by the existence of an incomplete information about the types of speakers (clones). For each type is a particular matrix of results. Thus the efficient actions are different according to the type of speaker ignored by the clone. In the easiest case, one of the clone is perfectly defined while the other is of two possible types corresponding to two different matrix of results. This clone knows its type, however ignored by its speaker.

The game theory: strategic consideration enlightening the essence of the involved behaviors, by analyzing the terms of the cooperation between the speaker and his clone, and by identifying the essential determinants of the choice (to take the initiative or to leave it to the clone).

The strategic action must be consideration about the conduct of another as well as (in a game of infinite mirrors) consideration about the consideration that this other is having about us, which differentiate it from simultaneous choice. Introduction of the time dimension: rehearsal of an elementary choice from the starting point given by the statistical analysis of the different kind of results.

Then the most favorable case for a stabilization of the cooperation between the speaker and his clone, is when the speakers do know themselves and when the choice is repeatedly the same without a timing being given for the sequence to stop. This is leading to the scale model of the logical circuits now available for a further usage within our application.

The scale model we consider for our application uses several principles regarding the decisions for a choice. For example, is the past depending on the future in a sequential choice? In a sequential choice, the future would be involved in the way we build the storytelling about our past. This is the principle of non-separability intervening at a microscopic level. Implementing this concept at a macroscopic stage for more elaborated systems is one of the challenges presented. The principle of superposition is committed in the heart of the quantum theory: a microscopic system existing in several different states might also be in all these states in the same time, so to speak suspended between different realities, generating phenomenons of interference. This is exactly what is outlined in our unconscious choices where all our thoughts are layered.

Accordingly, in quantum physics it is like you had three possible ways to go back home during rush hours (GPS is using this concept): Some days, you take this itinerary, some others you take another one. But of course, you can only take one way at the time, and you cannot know whether another would have been faster. With quantum mechanics, you can take the three different itineraries at the same time (superposition of the states), but you don't specify on which you are until you've arrived. Then and only then, you choose the fastest itinerary (principle of the delayed choice we use in our application, where the optimization of a [symbol] future [symbol] choice seems to determine a previous choice of itinerary). The a posteriori shortest itinerary is a decoherence (choice of a unique reality), made possible thanks to a prior state of coherence (when all itineraries coexisted as possible: the tunnel effect).

This principle will be demonstrated by our application through the notion of differentiation, for a probabilistic model of differentiation or elimination by attributes. The speaker facing a complex offer will concede few time for his decision making (using a thinly crucial quantity of resources). Facing the difficulty of choosing among the multiple attributes of the possibilities, the speaker is using heuristics reducing time and cognitive cost for making his choice, but this process is concealing parts of his reasoning such as some attributes and even some possibilities. The speaker is focusing on a given attribute and is processing a limited volume of information only. Such a model provides a very good estimate of the behaviors (modality of horizontal and vertical differentiation of choices, substituted by a probabilistic approach: the behavior of an individual might then be predicted within a function of probability).

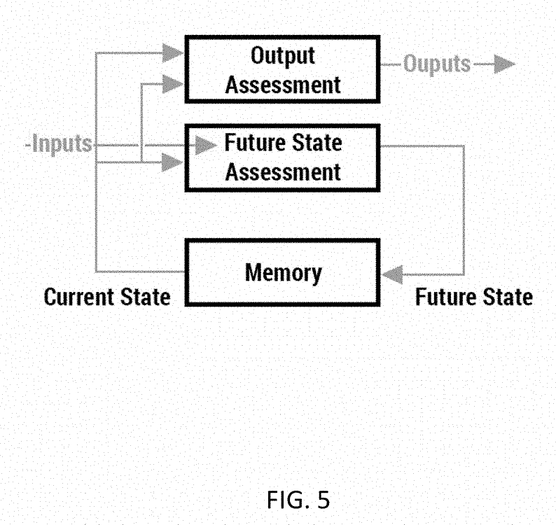

FIG. 5 is a functional block diagram of an exemplary logical circuit for use with the present invention, and describes three sequential systems.

First, a direct reaction system is shown in which delays are determined by the kind of operation in action; evolution depends on time of reaction of the operations (output assessment). Second, an imposed delays system is shown in which delays are identical or integer multiple of an elementary delay (future state assessment). Lastly, a scales system is disclosed in which delays (temporary memorization) are replaced by scales (continuous memorization).

The logical system is asynchronous when the output measures change according to the input variations (eventual delays of transmission of the operations in action).

The system is synchronous when it is ordered to change after the occurrence of a new state of input. Its evolution is thus controlled from the outside, by an additional input (orange input arrow) which is requisitely an impulse input in order to determine the momentum for the evolution to happen. Most of the time, these evolution orders are provided by a pulse generator added to the system and called the clock generator, or [symbol] clock [symbol] (mentioned further).

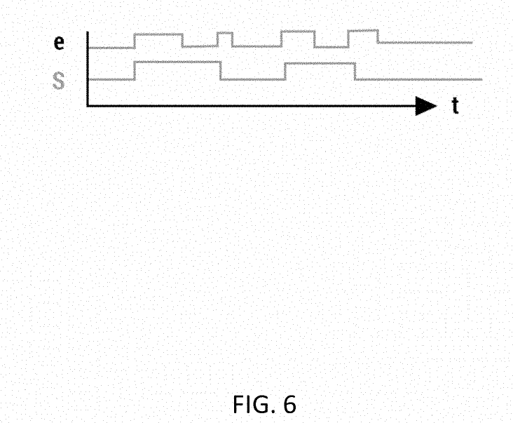

The sequential system coupled with combinatorial logics will be able to define a state, namely, 0 or 1. For example in a system with one [symbol] e [symbol] input and one [symbol] S [symbol] output, the output [symbol] S [symbol] must vary its value with each raising front of the input [symbol] e [symbol] , such as described in the chronogram shown in FIG. 6. For an identical value of [symbol] e [symbol] , [symbol] S [symbol] can have two values: 0 or 1. The realization requires scales, essential components of our application including the memories of the speaker and the clones.

A sequential system in the logical circuits of a chip is a system whose outputs at [symbol] t [symbol] time depend on the inputs at that same [symbol] t [symbol] time and also on what happened before: the story of the system. This story will be presented by a suite of states taken by the system through time. The modification of the state will be generated by the valorization of the inputs while the outputs are based on the state of the system.

Then we understand that a certain memory is being processed, and this memory lets the circuit remember about past events, and treating the information more efficiently.

Our application, thanks to its algorithm, won't be limited to this Markovian system though: a new state will be determined only from the just previous state and the inputs, because our application does consider the inferring states.

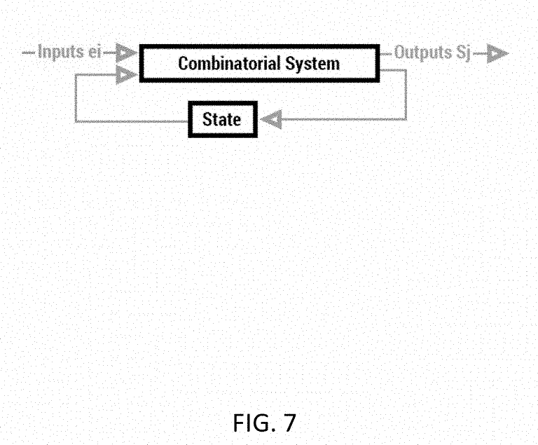

Referring to FIG. 7, an exemplary application uses a system inherent to digicodes and elevators. In embodiments, rather than using the ROM which is an addressable memory, but elements of memory sequentially motivated revealing the delay of data consultation in the circuit as a functional factor. In order to do so, we'll need to modulate with the signal propagation delay in the logical doors or introduce a feedback. Each logical door owns physical properties delaying the input's logical signals before any incidence on the logical value in the output (hazard or glitch).

We'll magnify and exploit these hazards in order to create an inferential memory phenomenon by introducing wisely ways of feedback in the combinatorial circuits, between outputs and inputs (XOR door: 2-inputs JK scale of master-slave type). It is going to be a finished-state machine: algorithmic sequence characterized by input vector, output vector and a sequence of states defining the behavior. This robot will leap from one state to another according to the input's sequences it will receive.

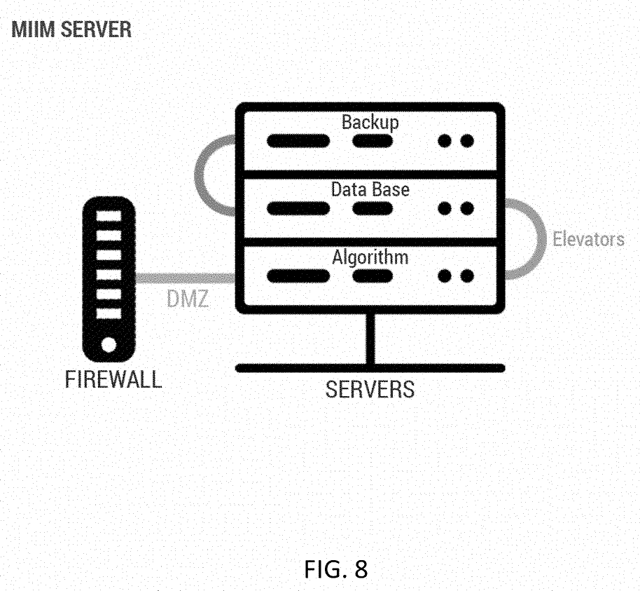

Referring to FIG. 8, three elements are shown for use with the system of the present invention, namely the algorithm, database and backup disk.

An input from the user is received and calculated by the algorithm and the 3D-clone is updated. The profile update generates new information about the user: new needs, new understandings, new questions. This new information is saved in the database. For security, the whole system is saved on an independent backup disk.

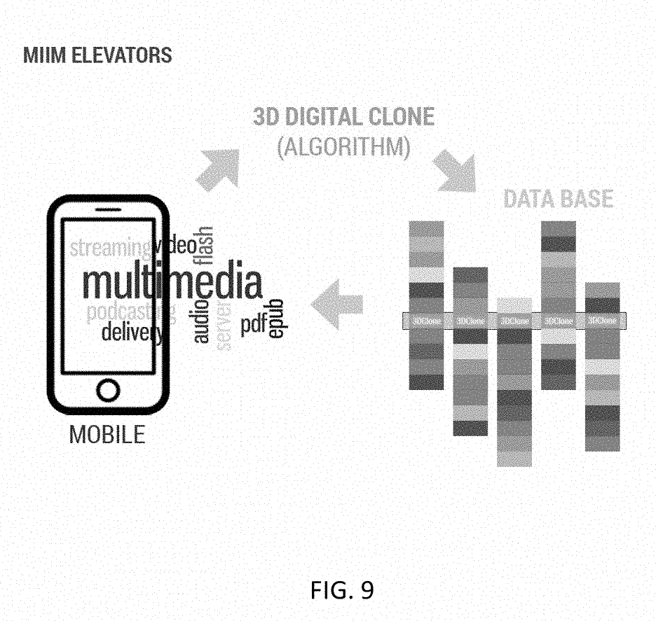

Referring to FIG. 9, information linked to the 3D-clone is enclosed in the database. The 3D-clone is continuously calculating the most relevant correlations between the previous inputs received from the user and the new categorized information suggested as matching the new needs, the new understandings and the new questions.

According to the personality clone generated by embodiments of the present invention, the application will select a coherent sequence of multimedia content enclosed in the MIIM's database such as text, sounds, images, and video. This application may design a unique sequence of content out of different categories. The visual representation of this section may be compared to several elevators moving side by side and stopping to make the right sequence aligned. Concretely, depending on the user's profile or personality clone, and progression in their personal inside journey, the sequence may result in a text generated from different paragraphs, illustrated by generated pictures (and/or videos, etc.) and inviting to enter into some actions. Then the application operates like a conversation the user has with themselves: on his/her end, he/she is questioning the app and improving the accuracy of the personality clone, and on the digital end, the algorithm answers with highly relevant content with the aim to help the user be more and more accurate in the definition of himself/herself.

Modelization of the Sequential Systems:

The specifications are composed of a suite of phrases describing the desired running of the system. This is the first step in the application's design. In order to analyze and validate the specifications, a working complex model of algorithm had been devised.

Elements of an exemplary algorithm include:

(1) Chronogram: graphic model representing on a timeline the evolution of all inputs and outputs within the system.

(2) Graph of fluence: graphic of the specifications (all stable states in the system and the chronological order the user is passing through from one to another according to the variable inputs).

(3) State tables: link polygons.

(4) State graph.

(5) Event graph.

(6) GRAFCET: representation of the command part of the automated production system.

(7) Petri's network: modelization of the production system analyzing the performances.

In embodiments of the invention, a fundamental hypothesis of the sequential systems is that non-correlated events never occur in the same time.

The future internal state for the system is equal to external inputs from other internal states (evolution) and external inputs from the same internal state (keeping).

This anticipation will be rendered thanks to a synchronous and asynchronous sequential system. In this system, the different options within the application will represent the changes of state and will be calculated after validation by the ascending (or descending) front of an additional signal called the clock. Concretely, our clock intervenes only on the memorization of the states, and is no additional input and doesn't influence the synthesis process. Asset of the system: the external inputs may switch at any time except on the active fronts of the clock. Inputs may even be synchronized by a serial of clocks in order to obtain stable information about the memorization board: basic functionality involved within our automated chip.

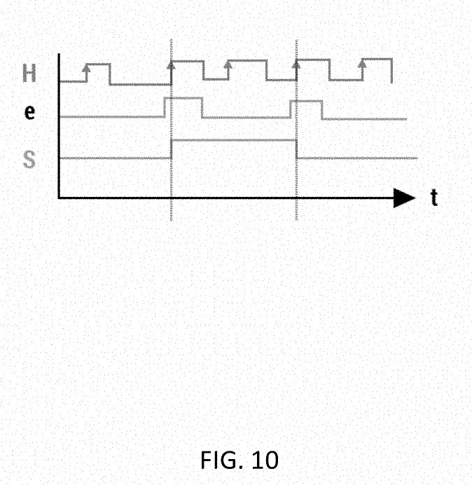

Referring to FIG. 10, the application algorithm may take place in a graphic of events made of parallel divergent sequences and a convergent synchronization (divergent and convergent).

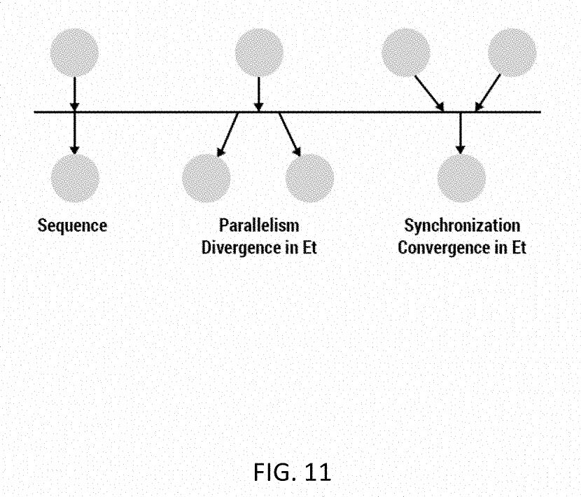

FIG. 11 is a depiction of various states of the system. States of the system are represented by circles (called place). Conditions of evolution (external input variables combination) make the system evolve: transition from a state to another state. These conditions are indicated by horizontal lines. An oriented arc binds a place (circle) to a transition (line), and a transition (line) to a place (circle). A transition is crossed when the state is active and when the related condition of evolution is true.

As a system is in one state only at a given time, in the state graph, only one place is active at a given time. Since in a state graph, each transition has exactly one arc in and one arc out, the conditions of evolution allowing to leave a state must be exclusive. Thus, we'll have the following structures: sequence/choice divergent parallelism in ET/convergence synchronization in ET (exclusive).

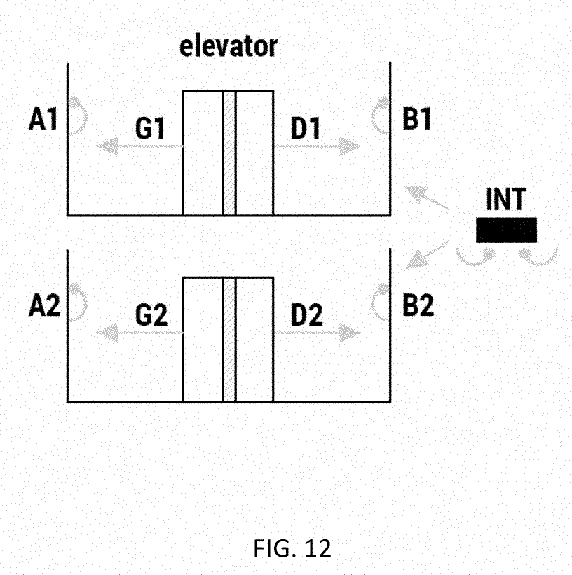

Referring to FIG. 12, an example of the elevator is shown with the interlocutor as the person answering the questions. By choosing 1 or 2, the elevator moves to the related floor: floor A1 if has chosen 1 in A1, floor A2 if has chosen 2 in A2, same for B1 and B2.

By asking the interlocutor [symbol] INT [symbol] if the choice [symbol] 1 [symbol] is in [symbol] A1 [symbol] (elevator on floor A1), if the choice [symbol] 2 [symbol] is in [symbol] A2 [symbol] (elevator on floor A2), then move the choice [symbol] 1 [symbol] towards [symbol] B1 [symbol] (elevator moves to floor B1), and the choice [symbol] 2 [symbol] towards [symbol] B2 [symbol] (elevator moves to floor B2). When the choice [symbol] 1 [symbol] is in [symbol] B1 [symbol] he goes back to [symbol] A1 [symbol] if the choice [symbol] 2 [symbol] has already passed to [symbol] B2 [symbol] ; when the choice [symbol] 2 [symbol] is in [symbol] B2 [symbol] , he goes back to [symbol] A2 [symbol] if the choice [symbol] 1 [symbol] has already passed to [symbol] B1 [symbol] .

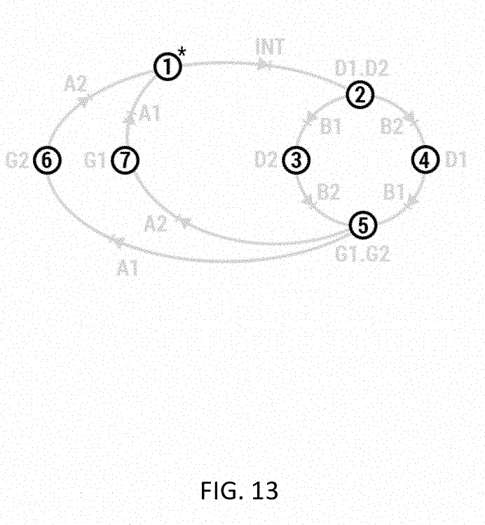

FIG. 13 shows a logical circuit in which a state graph is designed from the initial state chose. Five external input variables render 32 possible combinations. It is assumed that the two events ↓B1 and ↓B2 cannot occur at the same time. An event is produced by the change of level of a variable or a Boolean expression.

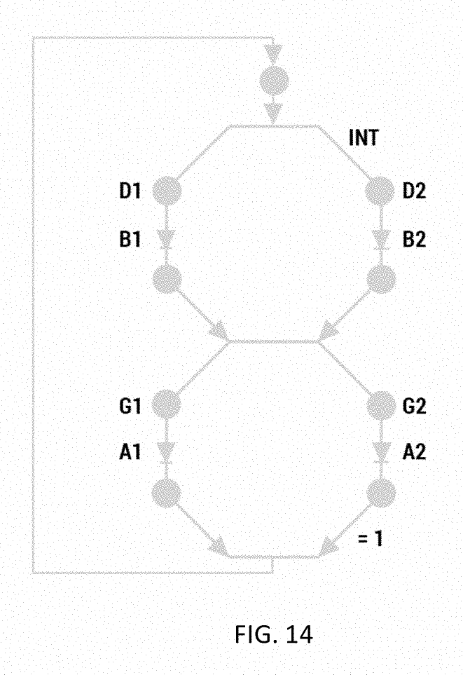

In the events graph, the application may consider the fact that each place has at the most one input transition and one output transition (parallelism and synchronization). A state is represented by the package of active places at any given time. The state graphs and the event graphs being not standardized, a graphic representation (FIG. 14) is shown close to the one in Petri's network where 1 is the mark for transitional conditions that are always true. These conditions will be overcome as soon as the very previous places are activated.

This first step in the algorithm leads to the following state table:

| INT.A.B | 0.0.0 | 0.0.1 | 0.1.1 | 0.1.0 | 1.1.0 | 1.1.1 | 1.0.1 | 1.0.0 | G.D |
|---|---|---|---|---|---|---|---|---|---|
| a | — | — | — | a+ | b+ | — | — | — | 0.0 |
| b | b+ | c+ | — | b+ | b+ | — | — | b+ | 0.1 |
| c | c+ | c+ | — | a+ | — | — | — | — | 1.0 |

Let the equation of evolution and keeping describe the future internal state:

b+=f(INT,A,B,a)+f(INT,A,B,b)

a+=f(INT,A,B,c)+f(INT,A,B,a)

c+=f(INT,A,B,b)+f(INT,A,B,c)

The chip will calculate the equations of evolution and keeping from each source state.

For b+:

Equation of evolution (ev): [symbol] b+ [symbol] may be reached from [symbol] a [symbol] only by exploiting the [symbol] a [symbol] line of the reduced state table:

| B\INT.A | 0.0 | 0.1 | 1.1 | 1.0 |
|---|---|---|---|---|
| 0 | x | 0 | 1 | x |
| 1 | x | x | x | x |

Then b+ev=INT.a

Equation of keeping (maint): exploit the [symbol] b [symbol] line of the table:

| B\INT.A | 0.0 | 0.1 | 1.1 | 1.0 |
|---|---|---|---|---|
| 0 | 1 | 1 | 1 | 1 |
| 1 | 0 | x | x | x |

Then b+maint=B′.b

Finally: b+=INT.a+B′.b, and and for the whole system:

a+=A.c+INT′.a

b+=INT.a+B′.b

c+=B.b+A′.c

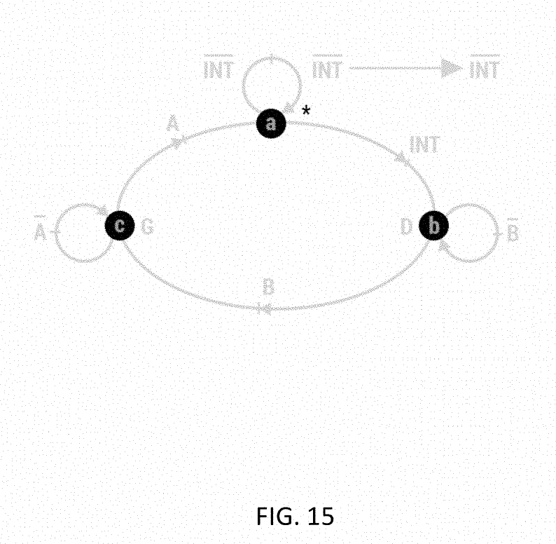

FIG. 15 shows a rendering of this first algorithmic premise. The system being in the [symbol] a [symbol] state, if the condition INT becomes [symbol] true [symbol] , then it switches to the state [symbol] b [symbol] . The INT condition may then disappear, and [symbol] B′ [symbol] is keeping the system in the [symbol] b [symbol] state.

Within the chip, outputs may only be written according to the state functions. Thus, let D=b and G=c. Add an algebraic formula where the outputs are written according to the states and external inputs. Thus, let: G=(ac).A and D=b.

Considering the initialization in the equations of the system, add an additional external input [symbol] I [symbol] , let: a+=A.c+INT′.a+I and b+=(INT.a+B′.b),I′ and c+=(B.b+A′.c),I′.

By making [symbol] I=1 [symbol] the system is reset into its initial state. Authorize the running by making: [symbol] I=0 [symbol] .

As a reminder, the technical correspondence in the application for these algebraic equations are the logical circuits using D or JK scales, synchronous and asynchronous.

In embodiments of the invention, an automated system may be composed of two distinctive parts, namely: (1) The operative part (PO): operating and acting power (the muscle). (2) The conductive part (PC): knows what is to be done, commands the operative part (the brain).

Inputs (entrées) are Boolean information coming from either sensor (A or B), or speaker (INT) when he'll ask a question or will choose an elevator.

Outputs (sorties) are either the orders sent to the operative part, or signals on the device screen (motions).

At this stage, the usage of the Grafcet (cybernetic model) will help our algorithm be integrated into a sequential system model for the commanding parts of the automatism.

This graph includes two types of hub: places and transitions. Oriented arcs are linking places to transitions, as well as transitions to places (like in the state and event graphs here above).

Step: A step being active or inactive: for an active step, we associate an action and a step that will work when the step will be activated.

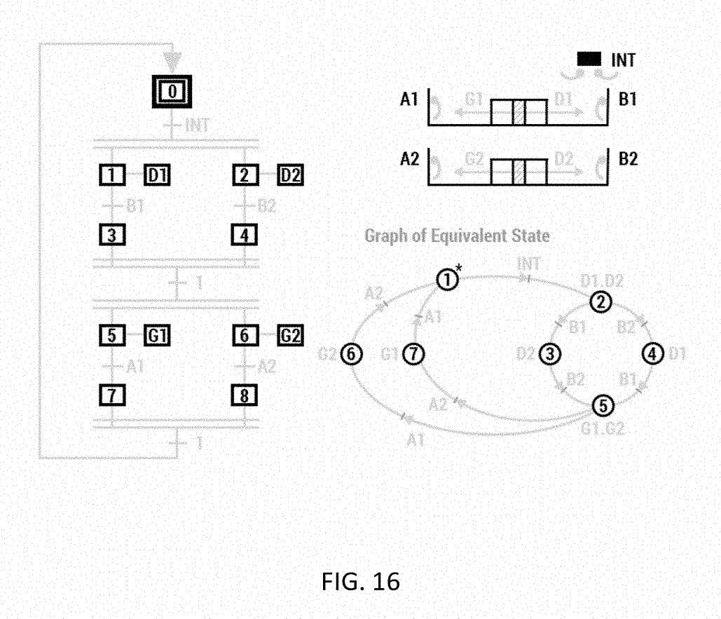

Transition: By the side of the transition, we'll write the condition of validation (receptivity): If the condition is always [symbol] true [symbol] , we write [symbol] 1 [symbol] . See FIG. 16.

The evolution of the situation operates by crossing the transitions. A transition is crossable if and only if: Steps prior to the transitions are active (validated transition). Transition receptivity is [symbol] true [symbol] . Then transition will be crossed by: Deactivating all steps prior to the transition. Activating all the steps after the transition. And this, simultaneously. We'll be able to link continuous, conditional or time-delayed variables of action.

Interpretive Algorithm:

In embodiments, from any input chronogram, the Grafcet application renders the corresponding outputs chronogram. The interpretation will be clear as a result of the interpretative algorithm, thanks to two hypotheses: (1) Two non-correlated external events cannot occur simultaneously. (2) A Grafcet has enough time to reach a state of stability between two distinctive occurrence of external events (the transition duration from a stable state to another is zero).

The steps in an exemplary algorithm may be as follows:

Step 1: (initialization): activation of the initial steps for INT and execution of the related impulse actions (go to step 5).

Step 2: when a new external event occurs, determining the package [symbol] T1 [symbol] of crossable transitions according to the occurrence of this event. If [symbol] T1 [symbol] is not empty, go to step 3. Otherwise, modifying eventually the state of the conditional actions associated to the active steps (indeed, certain actions may depend on conditions whose values may have changed). Wait for a new external event in step 2.

Step 3: crossing all the crossable transitions. If the situation is not modified after this simultaneous crossing, go to step 6.

Step 4: executing all the impulse actions related to the activated steps in step 3 (including the initialization of the temporizations).

Step 5: determining the [symbol] T2 [symbol] package of crossable transitions over the [symbol] e [symbol] event occurrence (ever occurrent). If [symbol] T2 [symbol] is not empty, go back to step 3.

Step 6: a stable situation has been reached.

Step 6.1: determining the [symbol] A° [symbol] package of level actions to be deactivated (actions related to active steps in step 2 which are now deactivated, and conditional actions related to still active steps whose conditions are no longer validated)

Step 6.2: determining the [symbol] A1 [symbol] package of level actions that must be active (actions related to inactive steps in step 2 which are now active eventually under conditions, and conditional actions related to still active steps whose conditions have now been validated while they were not in step 2).

Step 6.3: resetting to [symbol] 0 [symbol] all the actions belonging to [symbol] A° [symbol] and excluded from [symbol] A1 [symbol] .

Resetting to [symbol] 1 [symbol] all the actions belonging to [symbol] A1 [symbol] . Go to step 2.

It should be noted that the loop [symbol] 3 4 5 3 [symbol] allows an evolution until the next stabilized situation. An impulse or memorized action (S and R) is executed even if the situation is not stabilized yet. A level action is not modified in the gap between two stabilized situations. Step 6.3 secures the continuum of level 1 actions. As soon the algorithm returns to step 2, time restarts until next external event occurs. This algorithm might be used for the implementation of the Grafcet.

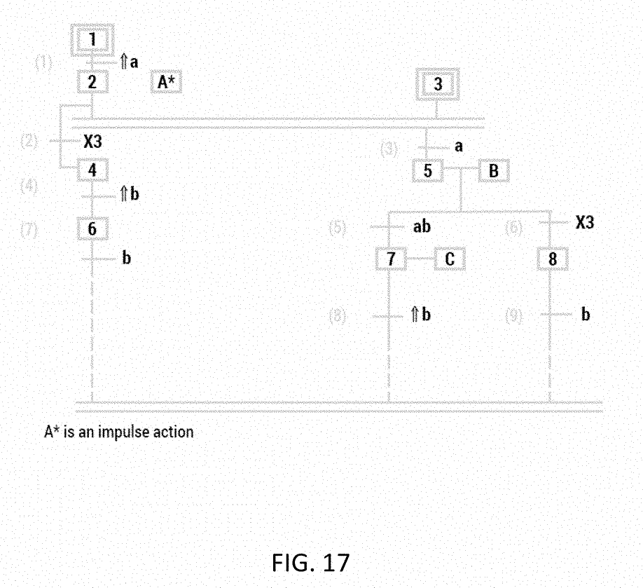

FIG. 17 shows a Grafcet (diagram), which is monetization tool for sequential systems, especially for automated orders parts. Grafcet is composed of two types of node: places and transitions. Oriented arcs bind places to transitions, and the transitions to the places (just like the state graph and the event graph).

The step is represented by a square. The initial step is represented by a double square. A step can be active or inactive. An active step is represented by a mark in the step. Eventually, an action can be associated to the step (this action will operate when the step is active). The condition of validation (receptivity represented by a letter or a number) is written by the side of the transition bar (horizontal line).

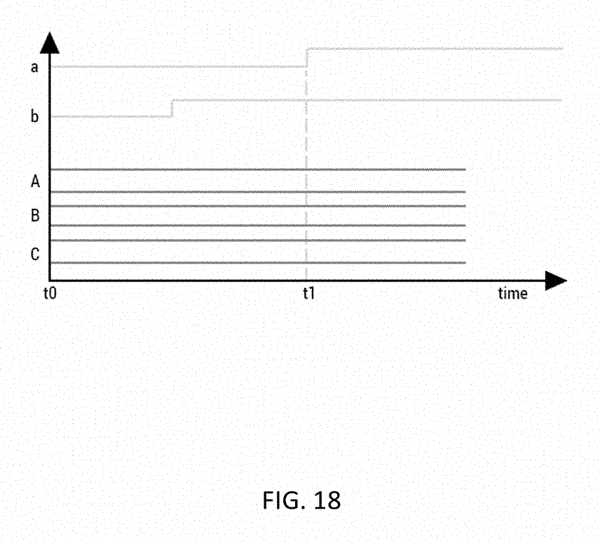

FIG. 18 demonstrates the evolution of the Grafcet by showing at every t time what its situation is (the pool of all the active steps). The situation of the Grafcet (at a given time) is the pool of all the active step at this given time. This situation of the Grafcet corresponds to a state of the system. The evolution of the situation proceeds by crossing the transitions.

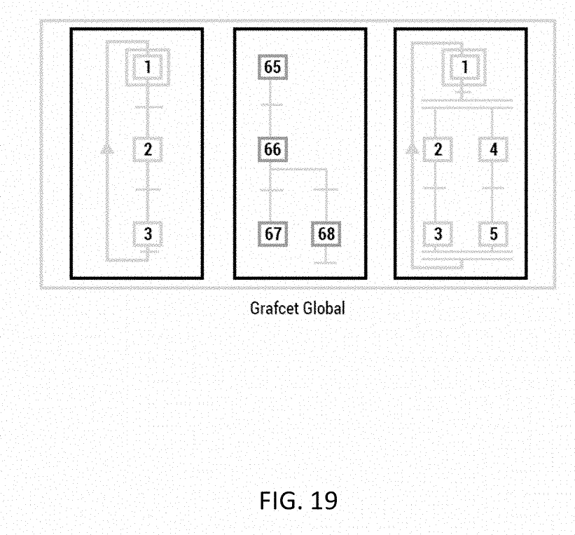

Referring to FIG. 19, the whole package of steps and transitions for a single command within our application will be divided into several connected Grafcets. These Grafcets are gathered in sub-packages (composed of a single element most of the time): partial Grafcets. The gathering of these partial Grafcets will be the command for the related system. Each and every partial Grafcet has its own unique number.

Besides, in our finished-state automate, an input [symbol] X [symbol] displays (S2 S1 S0) at the output the number of occurrence for [symbol] 0 [symbol] . The count is decreased every time a [symbol] 1 [symbol] appears at the input. If a sequence of four [symbol] 0 [symbol] appears at the input, the count is reset to [symbol] 0 [symbol] .

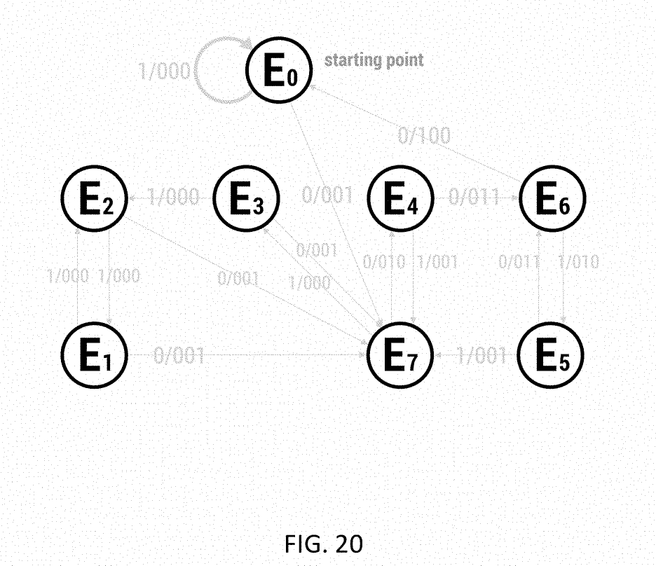

FIG. 20 shows a related state diagram. As shown in the state table below, outputs depending on inputs, the outputs column is divided according to the value of the inputs.

| | |
|---|---|
| Future state | Outputs(S2S1S0) |
| Input X | Input X |

| Current state | 0 | 1 | 0 | 1 |
|---|---|---|---|---|
| E0 | E7 | E0 | 001 | 000 |
| E1 | E7 | E2 | 001 | 000 |
| E2 | E7 | E1 | 001 | 000 |
| E3 | E7 | E2 | 001 | 000 |
| E4 | E6 | E7 | 011 | 001 |
| E5 | E6 | E7 | 011 | 001 |
| E6 | E0 | E5 | 100 | 010 |
| E7 | E4 | E3 | 010 | 000 |

Eight states must thus be crossed the number of variables. We may encode these states in 3 bits written as e2e1e0. The encoding system is shown in the below transition table:

| | E0 | E1 | E2 | E3 | E4 | E5 | E6 | E7 |
|---|---|---|---|---|---|---|---|---|
| Code e2e1e0 | 000 | 001 | 010 | 011 | 100 | 101 | 110 | 111 |

| Current | Future state (e2+e1+e0+) | | Outputs (S2S1S0) | |
|---|---|---|---|---|
| state | Input X | | Input X | |
| e2e1e0 | 0 | 1 | 0 | 1 |
| E0 | 111 | 000 | 001 | 000 |
| E1 | 111 | 010 | 001 | 000 |
| E2 | 111 | 001 | 001 | 000 |
| E3 | 111 | 010 | 001 | 000 |
| E4 | 110 | 111 | 011 | 001 |
| E5 | 110 | 111 | 011 | 001 |
| E6 | 000 | 101 | 100 | 010 |
| E7 | 100 | 011 | 010 | 000 |

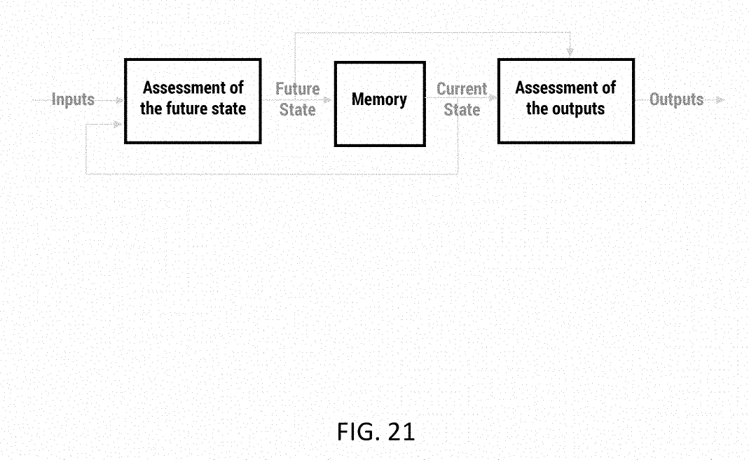

Referring to FIGS. 20-21, a combinatorial circuit (1) assessing the future state from the current state and inputs, (2) showing the circuits that we're going to implement.

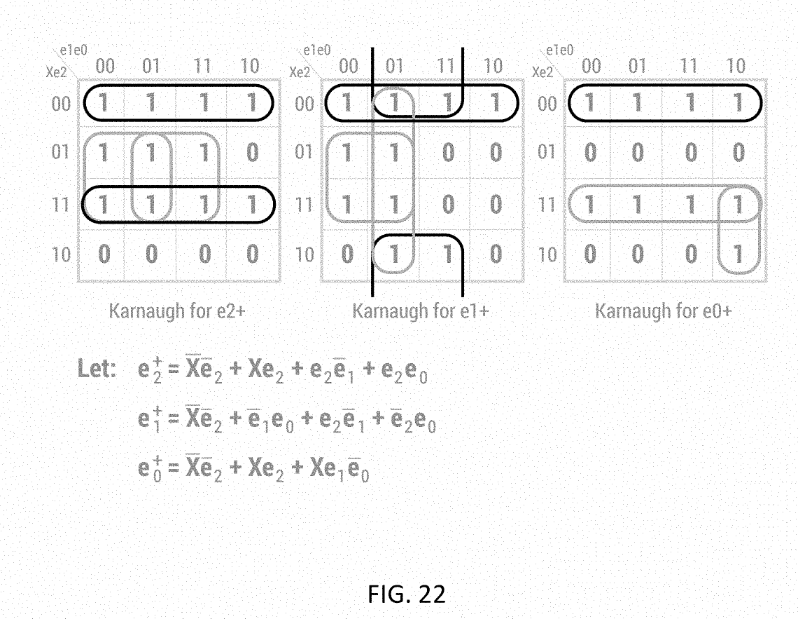

Four inputs e2e1e0 and [symbol] X [symbol] exist for the input as well as 3 outputs e2+e1+e0+. This leads to the following sequential logical circuits shown in FIG. 22.

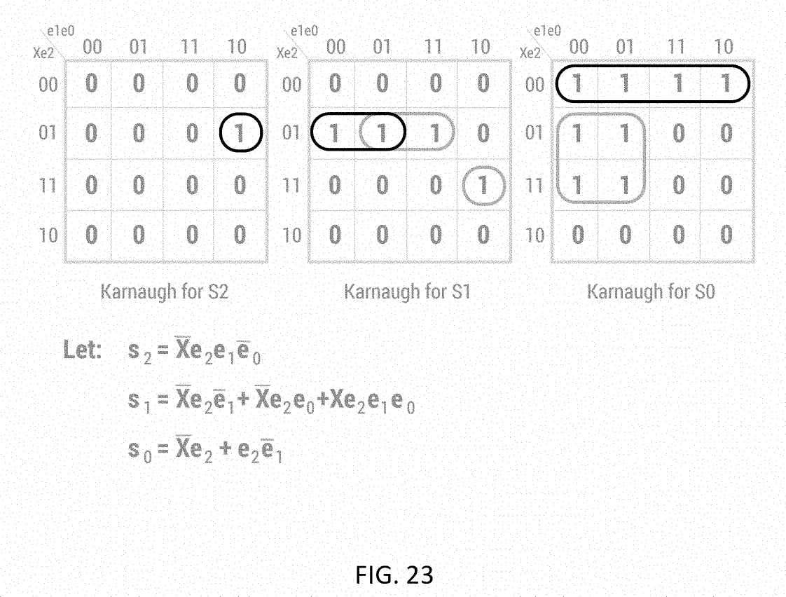

Four inputs e2e1e0 and input [symbol] X [symbol] , three outputs S2S1S0 are shown in FIG. 23.

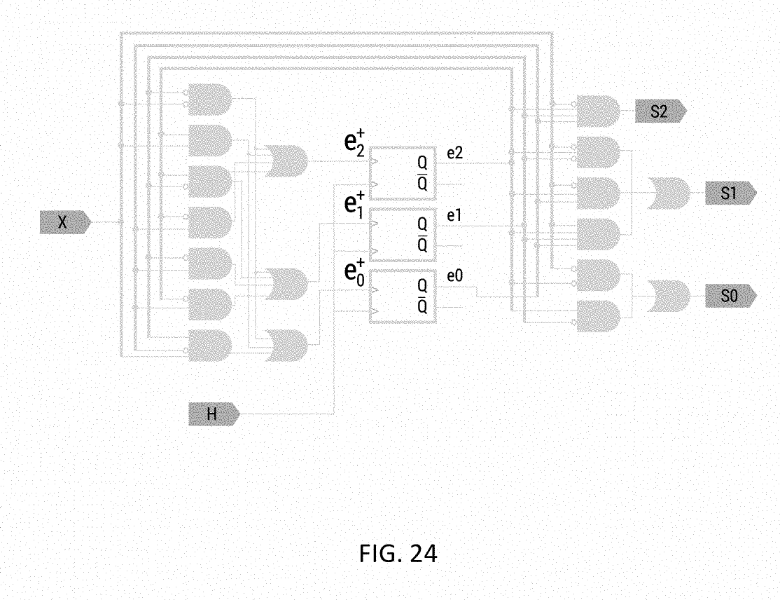

FIG. 24 shows a schema of the scales.

It will be understood that there are numerous modifications of the illustrated embodiments described above which will be readily apparent to one skilled in the art, such as other combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A computer-based system for improving self-knowledge and personal skills comprising:
a memory;
storage;
and a processor configured to perform the steps of:
interacting with a user to stimulate facts of memory according to a retroactive process of validation, and record responses so that a three-dimensional model of the user's personality may be developed, wherein said model comprises multiple layers of personality traits;
securely storing said model in said storage;
calculating the classical and quantum probability that the user will activate at least one layer and causing a virtual situation to be presented to the user in response to the probability, wherein said virtual situation comprises a plurality of attitudes leading to statistical outcomes; and
receiving data related to the user's interaction with the virtual situation, and utilizing said data to supplement the three-dimensional model.

2. The computer-based system of claim 1 wherein said processor is further configured provide a statistical prediction of the user's feelings, thought patterns and behaviors.

3. The computer-based system of claim 1 wherein said attitude includes one of: feelings, thoughts patterns, and behavior.

4. The computer-based system of claim 1 wherein said statistical outcomes include one of: emotion, beliefs, and behavior

5. The computer-based system of claim 1 wherein said facts of memory include one of: emotional memory, cognitive memory, and behavioral memory.

6. The computer-based system of claim 1 wherein said storage is a secure remote storage device connected to said processor via a network connection.

7. A non-transitory computer-readable medium having stored thereon computer-executable instructions for configuring a processor to perform the steps of:
interacting with a user to stimulate facts of memory according to a retroactive process of validation, and record responses so that a three-dimensional model of the user's personality may be developed, wherein said model comprises multiple layers of personality traits;
securely storing said model in said storage;
calculating the classical and quantum probability that the user will activate at least one layer and causing a virtual situation to be presented to the user in response to the probability, wherein said virtual situation comprises a plurality of attitudes leading to statistical outcomes; and
receiving data related to the user's interaction with the virtual situation, and utilizing said data to supplement the three-dimensional model.

8. The computer-based system of claim 7 wherein said processor is further configured provide a statistical prediction of the user's feelings, thought patterns and behaviors.

9. The computer-based system of claim 7 wherein said attitude includes one of: feelings, thoughts patterns, and behavior.

10. The computer-based system of claim 7 wherein said statistical outcomes include one of: emotion, beliefs, and behavior

11. The computer-based system of claim 7 wherein said facts of memory include one of: emotional memory, cognitive memory, and behavioral memory.

12. The computer-based system of claim 7 wherein said storage is a secure remote storage device connected to said processor via a network connection.

13. A system for improving self-knowledge and personal skills comprising:
a memory;
storage;
means for interacting with a user to stimulate facts of memory according to a retroactive process of validation, and record responses so that a three-dimensional model of the user's personality may be developed, wherein said model comprises multiple layers of personality traits;
means for securely storing said model in said storage;
means for calculating the classical and quantum probability that the user will activate at least one layer and causing a virtual situation to be presented to the user in response to the probability, wherein said virtual situation comprises a plurality of attitudes leading to statistical outcomes; and
means for receiving data related to the user's interaction with the virtual situation, and utilizing said data to supplement the three-dimensional model.
